(19) United States
(12) Patent Application Publication
(10) Pub. No.: US 2026/0279337 A1
(43) Pub. Date: Sep. 17, 2026

(54) ITERATIVE AUDIO AI VALIDATION AND ENHANCEMENT SYSTEM

(71) Applicant: International Business Machines Corporation, Armonk, NY (US)

(72) Inventor: Mikael Hillborg, Umeå (SE)

(21) Appl. No.: 19/188,360

(22) Filed: Apr. 24, 2025

(30) Foreign Application Priority Data
Mar. 11, 2025 (GB) 2503533.8

(51) Int. Cl. G10L 15/01

(52) U.S. Cl. CPC G10L 15/01

(57) ABSTRACT

A method, system, computer program product and computer program for enhancing an artificial intelligence, AI, audio system, the method comprising: receiving at least one audio test case, the at least one test case comprising a set of sound components; generating at least one an alternative audio test case, wherein generating comprises using a generative AI model to provide a first modification to the at least one test case; challenging the external audio AI with the at least one audio test case, and with the at least one alternative audio test case to determine a set of results; and comparing the results, using a distance function, to determine if the respective modification causes a problem in the external AI audio system.

### TECHNICAL FIELD

The invention is generally directed to artificial intelligence systems. In particular it provides a method, system, computer program product and a computer program for enhancing an artificial intelligence, AI, audio system.

### BACKGROUND ART

Speech-to-text systems need to be robust in the sense that they should cope with variations in input, both in terms of grammar and the understanding of rare words, but also in terms of how articulated a speaker is or isn't.

Speech can have different properties, which are either application specific or not known when the speech model was created. For example:

Many accents, regardless of the language, are based around omitting consonants, for example “Don't know” becomes “un no”. The initial d and k are pronounced with a reduced intonation. That is a challenge for speech-to-text systems, especially if more than just occasional words are spoken as in the example. If the reduced intonation is constant, then the system might have a problem picking it up properly. For example, if there are five words in a sentence and a few of these words couldn't be identified, AI models figure out what the word might be. For example, with the sentence “un no what the answer is” the speech-to-text system could fail to identify the first word but given the context it would conclude that it must be “Don't know”. However, if articulation is very limited, it can become difficult to identify sentences like “un no at e an er is” (don't know what the answer is).

Neurodegenerative diseases can result in speech which is different from “normal” speech, such as stuttering, extremely long pauses, wrong intonation, phonic tics, or audible breathing disorders.

Application specific properties of, for example, a speech-to-text system should be able to pick up a conversation in a loud and crowdy environment where lots of other conversations are going on. Many speech-to-text system manage that but there's a limit for all.

Which speech-to-text system used might be subject for the available compute resources, on-prem vs cloud, cost etc. Some can handle the above types of problems, with varying success, and some cannot.

When deploying a system that converts speech-to-text, it is desirable to know:
a) if it will fail to convert even the most basic (and not severe) cases that are cases of categories a), b) and c) above;
b) if it will fail for the more complicated ones only;
c) how it will perform for cases which are in between and which these cases are, in particular so the system can be retrained on such data.

A speaker who doesn't pronounce consonants well might be managed by a model, but there might be combinatorial problems, for example the model might fail if there's some background conversation which leaks consonants from the background conversation into the audio recording etc.

A speaker with a neurodegenerative disorder who chokes between every second or third word might be manageable by the model, but not if the person also breathes heavily and speaks with background noise.

Enterprise leaders may feel unsecure with generative AI, because they don't know if the application might generate problematic results for the enterprise even for input data that would seem normal from an LLM's point of view.

Multimodal AI are systems capable of processing and integrating multiple types of data inputs simultaneously, for example, text, images, audio and video signals.

Examples of multimodal AI include GPT-4 (OpenAI), Claude 3 (Anthropic), DALL-E 3 (OpenAI), and LLaVA (Large Language and Vision Assistant).

There's a need for a platform which allows for testing the performance of any AI platform that includes audio modality, by discovering potential problems in even corporately approved ordinary use cases. Another unknown is the sensitivity of such use cases to incremental parameter variations.

Therefore, there is a need in the art to address the aforementioned problem.

### SUMMARY OF INVENTION

According to the present invention there are provided a method, a system, a computer program product, and a computer program according to the independent claims.

Viewed from a first aspect, the present invention provides a computer implemented method for enhancing an artificial intelligence, AI, audio system, the method comprising: receiving at least one audio test case, the at least one test case comprising a set of sound components; generating at least one an alternative audio test case, wherein generating comprises using a generative AI model to provide a first modification to the at least one test case; challenging the external audio AI with the at least one audio test case, and with the at least one alternative audio test case to determine a set of results; and comparing the results, using a distance function, to determine if the respective modification causes a problem in the external AI audio system.

Viewed from a first aspect, the present invention provides a system for enhancing an external artificial intelligence, AI, system, the system comprising: a case generator for: receiving at least one audio test case, the at least one test case comprising a set of sound components; generating at least one an alternative audio test case, wherein generating comprises using a generative AI model to provide a first modification to the at least one test case; and challenging the external audio AI with the at least one audio test case, and with the at least one alternative audio test case to determine a set of results; and an analyser component for comparing the results, using a distance function, to determine if the respective modification causes a problem in the external AI audio system.

Viewed from a further aspect, the present invention provides a computer program product for enhancing an external artificial intelligence, AI, system, the computer program product comprising: a computer readable storage medium readable by a processing circuit and storing instructions for execution by the processing circuit for performing a method according to the invention.

Viewed from a further aspect, the present invention provides a computer program stored on a computer readable medium and loadable into the internal memory of a digital computer, comprising software code portions for performing the steps of the invention, when said program is run on a computer.

Preferably, the present invention provides a method, system, computer program product and computer program, wherein the AI audio system is one of a list, the list comprising: a speech-to-text system; a voice recognition system; a music recognition system; a text-to-speech system; and aspatial audio processing system.

Preferably, the present invention provides a method, system, computer program product and computer program, wherein generating at least one alternative audio test case comprises generating a further one of the alternative audio test cases, the further one of the alternative audio test cases comprising a second modification.

Preferably, the present invention provides a method, system, computer program product and computer program, wherein generating at least one alternative audio test case comprises generating a set of iterative alternative audio test cases, comprising a series of modifications to the at least one audio test case.

Preferably, the present invention provides a method, system, computer program product and computer program, further comprising: in response to receiving the at least one audio test case, creating a trajectory; for each increment on the trajectory, determining a set of operations mnemonics to apply; and wherein generating the set of iterative alternative audio test case comprises applying one of the operations mnemonics to the at least one audio test case to provide a corresponding modification. Preferably, the present invention provides a method, system, computer program product and computer program, wherein the second modification comprises a greater complexity level than the first modification, the complexity level comprising a level of feature change applied to the corresponding at least one audio test case.

Preferably, the present invention provides a method, system, computer program product and computer program, wherein the complexity level between the first modification and the second modification follows a complexity function. Preferably, the present invention provides a method, system, computer program product and computer program, further comprising: in response to determining a problem in the external audio AI system, sending information about the at least one alternative audio test case to the external audio AI system. Preferably, the present invention provides a method, system, computer program product and computer program, wherein a parameter defines which type of modifications the system is allowed to perform.

Preferably, the present invention provides a method, system, computer program product and computer program, wherein the distance function is a user defined distance function. Preferably, the present invention provides a method, system, computer program product and computer program, further comprising analysing the results to determine a frequency and/or clustering of the results.

The invention identifies the level of reduced “articulation” that is causing the system to fail, reducing the risk of deploying a system that would fail even for cases that might seem obvious, and it identifies combinatorial problems.

The current invention relates to a first system comprising an API that can be connected to a second system to iterate by supplying a set of audio test cases with or without features, which in each iteration brings AI generated variations of rising complexity of the test cases back according to a user defined complexity curve where the curve has a base complexity, a user defined shape and test case related properties, to measure exactly which weaknesses of the second system.

Advantageously, any external audio AI system can be connected through an API to supply a data set of ordinary audio test cases, which are analyzed and converted into a set of challenge items. The challenge items are created by computing a granularity of changes, a specific level of complexity, with user defined settings, through the invocation of a case generator that uses properties which are obtained from an audio modality property store. The invention makes it possible to determine the level of modification to benign data that is needed to provoke an error to the external audio AI system. This also allows an assessment of whether a potential weakness is associated with a particular feature. As a result, steps can be taken to improve the external AI system to improve its robustness.

Advantageously, the system iterates to create a set of challenges which constitutes a sequence of increasing complexity, where each iteration makes an incremental change of the challenge in terms of various properties the challenge has. This is performed with or without features that have been selected (manually or automatically). The system provides (a) a combinatorial analysis, (b) statistical analysis and (c) feature/non-feature analyses of weaknesses on all levels of complexity.

Advantageously, the system tests an external audio AI application. This might involve any type of underlying AI infrastructure, such as a foundation model or any type of AI. This can also reveal that the training set that was used to build the external AI system was insufficient. The system can supply more training cases to cover up for the lack of cases.

Advantageously, the system can be used to measure a large variety of external audio AI systems, since the system uses a variety of distance functions to measure whether it was the “same result” (or not), and since it supports multiple modalities.

Advantageously, the system takes an input audio test case supplied by the user and generates any number of variations. Each variation is compared with the original audio using a distance function.

Advantageously, the present invention provides a system that repeats to create a factor according to a user defined progression. The factor is sent as a set of parameters to the input of an audio processor module, which applies a set of operations according to the three categories {articulation, neuro, application} using algorithms obtained from an operation database. Two components are sent into a speech-to-text system, and outputs compared according to a user selected distance function. The results is passed to a module that derives single-and combinatorial deviations from the distance threshold to measure the single-and combinatorial sensitivity level of the speech-to-text system.

Advantageously, the system allows modified audio to be generated from speech to measure sensitivity for certain types of operations to the audio, so the output of a speech-to-text system can be tracked when/if it fails to interpret the audio which has some of the properties as defined by operations in an operation database.

The present invention is concerned with modifying audio, in particular, in the system, to generate data. The invention protects how audio, with a focus on speech, is generated. Using an audio processor, a database of audio and speech operations (pause, stuttering etc.) and a pairwise validation of audio recordings, where the operations in the database adhere to speech properties such as accents, neurodegenerative properties and application specific properties such as location (e.g. background indoor or outdoor noise, like crowds or vehicles).

### BRIEF DESCRIPTION OF THE DRAWINGS

The present invention will now be described, by way of example only, with reference to preferred embodiments, as illustrated in the following figures:

FIG. 1 depicts a computing environment, according to an embodiment of the present invention;

FIG. 2 depicts a high-level exemplary schematic flow diagram depicting operation methods steps for an iterative audio AI validation and enhancement system, according to a preferred embodiment of the present invention;

FIG. 3, depicts a high-level diagram depicting components of an external AI system and a system, according to a preferred embodiment of the present invention;

FIG. 4 also depicts a high-level diagram depicting components of the external AI system and the system, according to a preferred embodiment of the present invention; and

FIG. 5 depicts test cases, according to a preferred embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

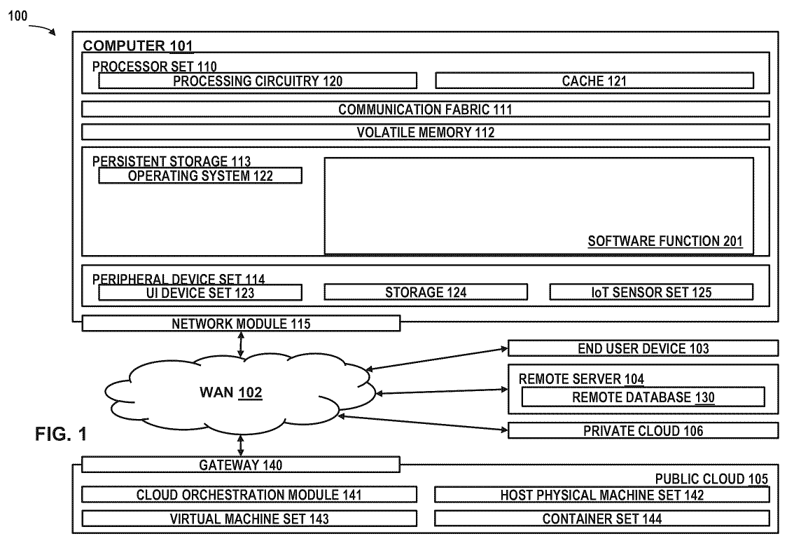

FIG. 1 depicts a computing environment 100. Computing environment 100 contains an example of an environment for the execution of at least some of the computer code involved in performing the inventive methods, such as software functionality 201 for improved rule extraction. In addition to block 201, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 201, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard disk, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein. It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above invention may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

Moreover, the same or similar reference numbers are used throughout the drawings to denote the same or similar features, elements, or structures, and thus, a detailed explanation of the same or similar features, elements, or structures will not be repeated for each of the drawings. The terms “about” or “substantially” as used herein with regard to thicknesses, widths, percentages, ranges, etc., are meant to denote being close or approximate to, but not exactly. For example, the term “about” or “substantially” as used herein implies that a small margin of error is present. Further, the terms “vertical” or “vertical direction” or “vertical height” as used herein denote a Z-direction of the Cartesian coordinates shown in the drawings, and the terms “horizontal,” or “horizontal direction,” or “lateral direction” as used herein denote an X-direction and/or Y-direction of the Cartesian coordinates shown in the drawings.

Additionally, the term “illustrative” is used herein to mean “serving as an example, instance or illustration.” Any embodiment or design described herein is intended to be “illustrative” and is not necessarily to be construed as preferred or advantageous over other embodiments or designs.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

For the avoidance of doubt, the term “comprising”, as used herein throughout the description and claims is not to be construed as meaning “consisting only of”.

Generative AI is a type of artificial intelligence that can create original content, such as text, images, audio, video, code etc., in response to user prompts or requests. Generative AI uses neural network models which may have a variety of topologies. These models work by identifying and encoding the patterns and relationships in huge amounts of data. One example of generative AI is ChatGPT.

In general generative AI operates in three phases:
a) Training, to create a model that can serve as the basis of multiple generative AI applications.
b) Tuning, to tailor the foundation model to a specific generative AI application.
c) Generation, evaluation and retuning, to assess the generative AI application's output and continually improve its quality and accuracy.

Data-based generative AI refers to artificial intelligence models that are trained on large datasets to generate new content or data that is similar to the training data. These models learn patterns and structures from the input data, allowing them to create novel outputs across various domains.

A language model is an example of generative AI, which have shown significant potential for rule extraction and learning tasks, offering several advantages in this domain. Language models don't need to be very large to be efficient. Another example of a language model is Large Language Model (LLM). LLMs can be leveraged for rule extraction in various ways. LLMs analyze vast amounts of text data to identify recurring patterns that can be translated into rules. This allows LLMs to extract implicit rules from unstructured data. Once rules are established, LLMs can generate inferences that align with these rules, improving their accuracy in tasks such as question answering and summarization. LLMs can assist in generating initial sets of logic rules for systems. Optionally, these initial sets can then be reviewed and refined, for example, by subject matter experts. LLMs are trained to predict the most probable next word according to training examples. For this purpose, the LLM computes a probability for each candidate word. A sampling procedure then randomly chooses one of the words according to these probabilities. A sequence of words is determined by repeating this procedure several times.

AI speech-to-text system (also known as Automatic Speech Recognition (ASR) models) work by converting audio input into text output using advanced machine learning techniques.

Typical ASR system method steps include:
a) Inputting an analogue signal, converting to the digital domain, removing noise and normalizing volume.
b) Extracting features to identify speech elements.
c) Passing the extracted features into an acoustic model, for example, a Recurrent Neural Network (RNN) or Transformer, to map the features to phonetic units.
d) Using a language model to predict the most likely sequence of words based on the context and grammatical rules of the target language.
e) Decoding the acoustic and language model outputs through combination to determine a probable sequence of words that correspond to the input audio.

Example ASR models include end to end, transformer-based encoder-decoder architectures, and natural language processing (NLP) models. Some ASR models use “diarization” to identify different speakers in an audio.

Convolutional neural networks (CNNs) use convolutional layers with filters and pooling layers to extract features from input data. Recurrent neural networks (RNNs) have a recurrent structure with loops that allow information to persist, enabling them to process sequences of varying lengths.

Sound recognition can be made using spectral analysis, processed by RNNs, including Long Short-Term Memory (LSTM) networks, or CNNs depending on the specific audio processing task.

The “training” cases of an AI model are not the same as its “test” cases (also known as “use” cases). These are distinct datasets used for different purposes in the development and evaluation of AI models.

Training case data is used to teach the AI model patterns and relationships. The model learns directly from this data to adjust its parameters and improve its performance. Training case data is used for learning. Test data, on the other hand, is a separate dataset used to evaluate the model's performance after training is complete. This data is completely new to the model and serves as a final, real-world check to confirm that the AI algorithm was trained effectively. Test case data is for evaluation.

An AI system is customized to meet a specific scenario or application where artificial intelligence can be used to solve a business problem or improve a process. In contrast, “training cases” are part of the data used to train AI models, which is a step in developing AI solutions for the specific scenario.

Generative AI can create suitable test cases for another AI system through a multi-step process that leverages machine learning techniques and domain-specific knowledge.

The following are typical steps:

Data Collection and Analysis: The generative AI first gathers and analyzes relevant data, including existing test cases, software requirements, scenarios and specifications related to the target AI system. Using natural language processing, the AI interprets the requirements and specifications of the target system to understand its purpose and functionality. The generative AI identifies common testing patterns and applies them to the specific context of the target AI system.

Test Case Generation is based on the analyzed data and understood context, the AI generates a diverse set of test cases that cover various scenarios, including edge cases.

Optimization for AI training is made by tailoring the generated test case specifically for training the other AI system by ensuring a wide range of input variations to improve the target AI's generalization capabilities, including edge cases and unusual scenarios to enhance the target AI's robustness, and generating synthetic data that mimics real-world scenarios the target AI might encounter.

Examples of generative AI are foundation models and traditional machine learning.

Generative AI modifies test cases in several ways:
a) Automated test case generation: analysis of existing data, code, and user interactions to create diverse and thorough test cases, including edge cases and varied scenarios.
b) Continuous updating: as software evolves, generative AI constantly updates and generates new test cases, ensuring test suites remain relevant.
c) Test case optimization: AI models can identify and prioritize the most critical test cases, improving test coverage efficiency.
d) Adaptation to code changes: generative AI can automatically select and create regression tests based on recent code modifications, focusing on potentially impacted areas.
e) Enhancement of existing test cases: AI can augment existing test cases with additional details, such as steps and expected results, making them more comprehensive.

Learning from historical data: the AI model learns patterns and relationships from existing test case data, using this knowledge to generate new, similar test cases.

Audio may be modified using generative AI as well, for example (but not limited to) using autoregressive models, diffusion models or token-based representation.

A foundation model in generative AI is a large-scale, pre-trained machine learning model that serves as a versatile base for a wide variety of AI applications. These models are trained on massive datasets to learn patterns and relationships. Examples include DALL-E, Claude and Stable Diffusion.

The skilled person would understand that many types of generative ai could be used for case generation.

This invention is a device which features an iterative mechanism that uses generative AI to challenge any external audio AI system, using test cases provided by the user. The invention is illustrated using a speech-to-text system but other audio models that analyse audio recordings could be tested by the present invention.

For example, in a factory an AI system could analyse audio recordings from a machine for predictive maintenance. Another example is in the automotive industry where sensors in cars can analyse sound to identify approaching vehicles. The skilled person would understand that the invention can be applied to solve numerous technical problems. There are several types of audio AI systems, each designed for specific applications in sound processing and analysis: speech-to-text systems, voice recognition, music recognition, text-to-speech, spatial audio processing etc.

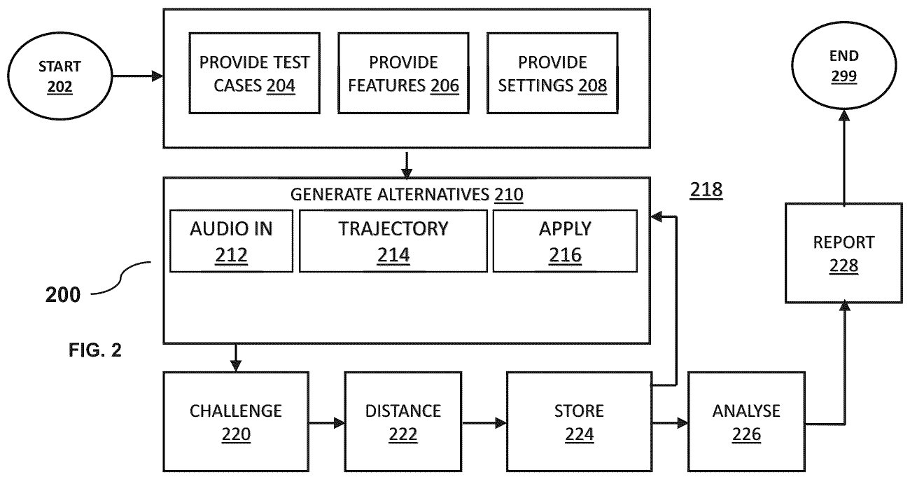

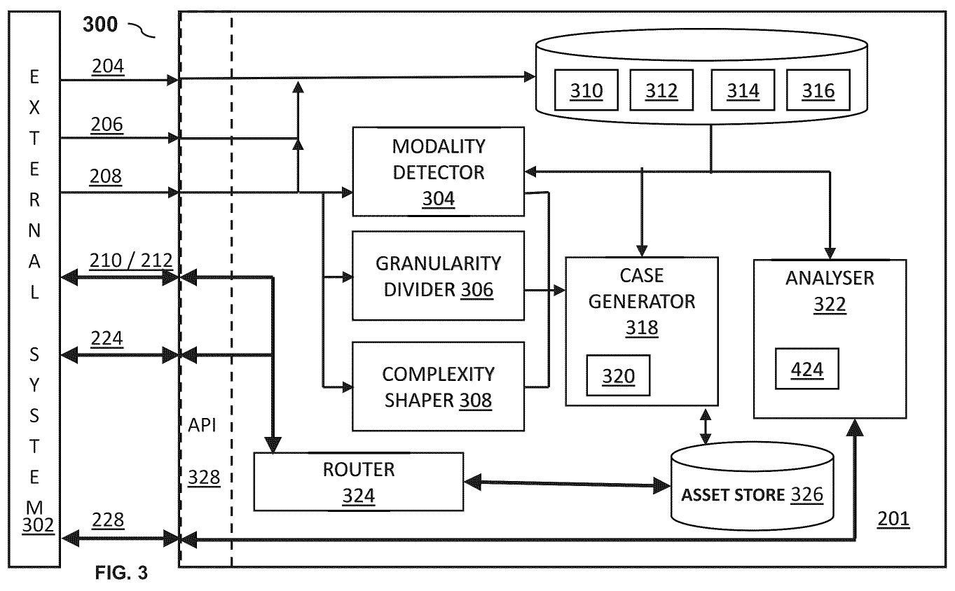

FIG. 2, which should be read in conjunction with FIG. 3-5, depicts a high-level exemplary schematic flow diagram 200 depicting operation methods steps for enhancing an artificial intelligence, AI, audio system, according to a preferred embodiment of the present invention.

FIG. 3, depicts a high-level diagram 300 depicting components of an external AI system 302 and a system 201, according to a preferred embodiment of the present invention.

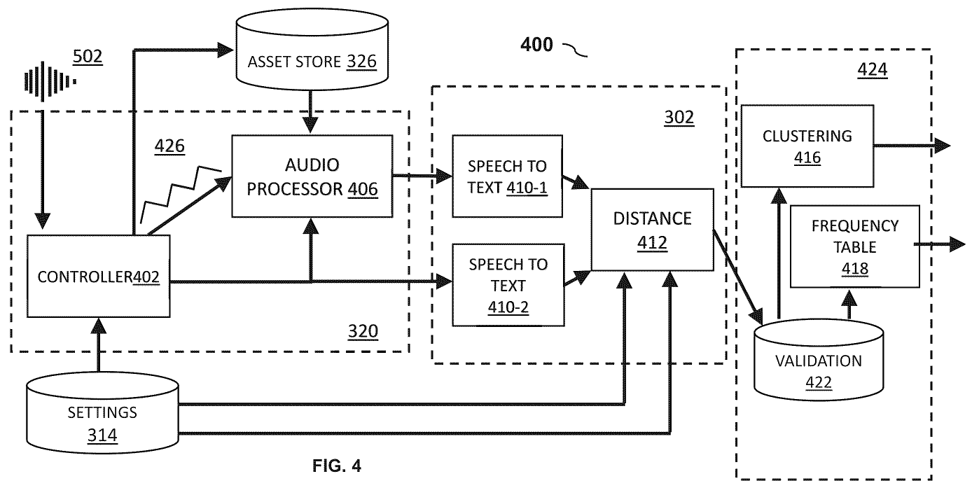

FIG. 4 also depicts a high-level diagram 400 depicting components of the external AI system 302 and the system 201, according to a preferred embodiment of the present invention.

The diagrams 400 and 300 are equivalent to each other, but with different topologies. Diagram 400 illustrates a flow of artifacts of the invention.

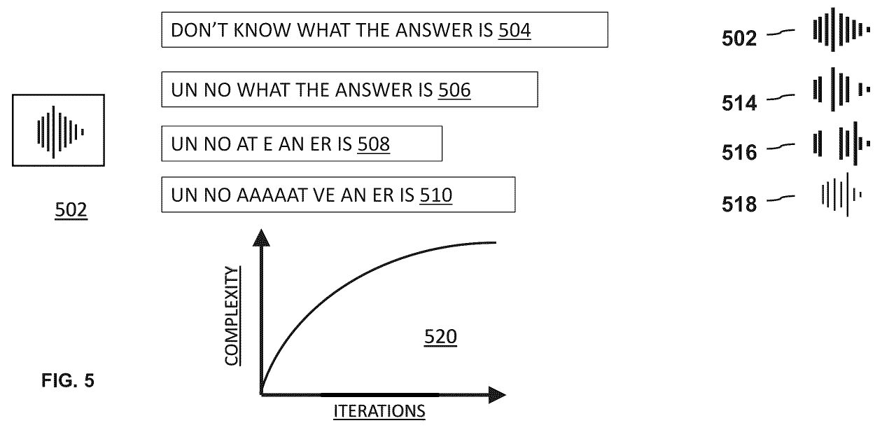

FIG. 5 depicts test cases 502, and alternative test cases 504, 506, 508, 510, 514, 516, 518. In a preferred embodiment, test cases 502 are suitable for a speech-to-text external AI system 302, and are modified to produce alternative test cases 506, 508, 510.

The method starts at step 202.

At step 204 a set of audio test cases 502 are provided to software functionality of the system 201 (hereinto described as the system 201) from the external AI system 302. The test cases 502 are stored in a document store 310. The base audio test cases 502 may comprise a digital audio file 502, which represents a series of sound components.

At step 206 the system 201 is supplied with features. Features are stored in a feature store 312. As part of the feature set a level of complexity can be set by a complexity shaper 308. For example, the level can be set at a figure that goes from 1 to 100 for each modality, where 1 represents a tiny change of complexity, 50 is a medium change and 100 is the highest level of complexity. The skilled person would understand that other measures of complexity are possible. For audio, the lowest level of complexity could mean that only a few sound components in a text output are modified. The highest could mean that sound components in all words are modified. Complexity variation may be made by the complexity shaper 308 according to a defined profile set by a user. The features may also comprise a parameter which defines which type of modifications the system is allowed to perform.

At step 208 the system 201 is supplied with settings for a set of iterations. The settings are stored in a session store 314.

At step 210, the set of audio recordings 502 are provided to a modality detector 304. The modality detector 304 assigns a modality of “audio” to each audio recording before passing the set of set of audio recordings 502 to the case generator 318. Different modalities have different methods for generating the cases, for example a generated case for a prompt is totally different from a generated case for an image. Therefore, the modality property store 316 contains a set of operations that applies to each specific modality. Examples of properties for audio: signal to noise ratio, clicks, pops, encoding etc.

At step 210 the case generator 318 uses generative AI, using content from the document store 310, feature store 312, session store 314, and modality store 316 to generate alternative versions 504, 506, 508, 510 of the test cases 502. Generative AI is used to generate audio which has certain types of frequency components and certain types of intonation, for the case of speech, for example. Reductions or boosts to transients and other components are made. This uses generative AI to provide high quality results.

At step 212, the case generator 318 receives audio 502 into a controller 402. At step 214, the system 201 creates a trajectory 520 of a certain granularity (resolution). For each point on the trajectory the system 201 puts together a list of one or more operations mnemonics to apply. A mnemonic is a memory aid designed to help recall information. In the context of the invention an “operation mnemonic” is a piece of text that identifies which type of AI that should be applied to transform the original recording into something else. For example, GENAI_CONSONANTS could mean that generative AI is used to transform speech where consonants are pronounced in a different way than in the original recording. Or even GENAI_ACCENT_3 could mean that generative AI should be used to transform speech so it has an accent of type 3.

At step 216 an audio processor 406 applies the list of operations on the audio 502 where the degree of processing is determined by a factor 426 on the trajectory 520. Operations might be to reduce the articulation of the speech, speak very fast, introduce stuttering, long pauses, add different types of background noise applying a set of operations according to the three categories {articulation, neuro, application}.

The test case 502, and its corresponding alternative test cases 504, 506, 508, 510 act as challenges to the external AI system 302.

At step 220 a router 324 sends the processed audio (e.g. alternatives 506, 508, 510) through a first call 410-1 to the speech-to-text system 302. The clean unprocessed audio (i.e. the original test case 504) is also sent through a second call 410-2 to the speech-to-text system 302.

At step 222, the outputs from each of the two speech-to-text system calls 410-1, 410-2 are sent to a distance component 412, which measures whether the distance according to a user defined distance function semantics is within the user defined threshold or not.

The distance component 412 uses a distance function to measure the outcome of both to determine whether the outcome should be regarded as the same or not. In machine learning the distance function gives the distance between elements of a set. A distance of zero indicates the elements are equivalent. Methods like classification, clustering, and retrieval require distance functions to define distances. The skilled person would understand that other measures of closeness or correctness could be used.

Distance function is used to measure how close the result of the challenge is to the result of the original test case. Original data is challenging the external AI system 302 and provides a result which is the expected result (because it's the original data supplied by the user). A variation is crafted and sent to the external AI system 302. The result of the alternative is supposed to provide the same response (within a certain distance). The distance function can be arranged so as to require, for example, an exact match, a first % text distance, or a first numeric scalar % distance.

Thus the distance component 412 determines whether the result of the external AI system 302, 410-1, 410-2 responding to the challenge meets requirements of the external AI system 302, and if not, which properties and combinations of properties may be causing problems for the external AI system 302. For example, in FIG. 5, the requirement is to correctly understand the audio input 401. If the modification from the original test case 502 to the first alternative 504 caused the external AI system 302 to identify the correct text, but the modification in the second alternative 508 caused the external AI system 302 to misidentify the correct text, the analyser 322 may conclude that the difference between the first alternative 504 and the second alternative 506 caused a problem.

At step 224 the external AI system 302 responds back over the API 328 including the IDs of the associated items in the set of audio cases 502 and the result. Since the challenge was generated from the set of audio cases 502 and an analyser 322 comprises a ground truth for the set of audio test cases 502, at step 226 the analyser 322 can trace which properties and combinations of properties may be causing problems for the external AI system 302. The ground truth acts as a baseline.

At step 224 an output of the distance function (a Boolean) is stored in a validation store.

The process is repeated 218 for the next (higher) point on the trajectory. The method iterates 218 until a maximum complexity has been reached. The complexity is increased at a certain granularity, determined by a granularity divider 306. The system 201 iterates to create a set of audio files which constitutes a sequence of increasing complexity, where each iteration makes an incremental change of the audio.

Thus a new iteration 218 can be set up. If the user makes a new iteration, then complexity increases or stays constant. The system 201 allows the complexity to rise linearly, non-linearly or to be constant.

For example, a first alternative 504 has no change. A second alternative 506 is depicted with the first two words at least missing leading consonants. A third alternative 504 is also depicted with all words, at least missing leading consonants. A fourth alternative 510 is also depicted with all words at least missing leading consonants as well as extra letters, and non-standard pronunciation (‘ve’for ‘the’).

At step 226, once the trajectory 520 has been traversed a statistics module 424 of the analyser 322 evaluates all Booleans in the validation store 422 and puts the failed operations in a frequency table 418 and applies a clustering algorithm 416 on the failed operations to identify if there were any combinatorial effects that caused the speech-to-text system 302 to fail.

One of the outputs is that of the frequency table 418 which identifies how many operations, which operations and which levels that caused the speech-to-text system 302 to fail. For example, there might be zero fails on the low levels and a higher degree of fails on the upper levels. Another output is that of the clustering algorithm 416, which locates any clusters of operations (combinations) that caused the system to fail.

The analyser 320 traces these properties, and combinations. For example, the analyser 322 checks if there are reoccurring property types and make a frequency table of these. The analyser 322 may also use more advanced methods as well, such as clustering, to identify combinatorial weaknesses.

By testing the alternatives in the same order (by using their IDs, which can be sorted), the user can see when the external image detection algorithm cannot identify the object any longer. And then it will be possible to get statistics on how weak the detection algorithm is, or in other words, how much of an object that needs to be either not visible or modified before it fails to identify it.

Thus the system 201 iterates with an increasing complexity in each iteration, carrying out multi-level testing of ordinary test cases 502 with or without features as provided by the user, to identify on which level of complexity there might be challenges which could impose problems for the organization.

The system 201 also uses methods to trace vulnerabilities within an audio modality. Tracing can be made with respect to a particular level of complexity which is either constant or can increase in different ways, configurable by the end user as the user iterates over challenges.

The system 201 sends information about the alternative test case to the external AI system as a training set. The information comprises for example, results of the analysis to the external AI system 302, the alternative test case that caused the external AI system 302 to fail, the audio vulnerability traces, and the ground truth to the external AI system 302, so that the external AI system 302 can use the information. If the challenge resulted in the external AI system 302 not being able to provide an expected response (compared to the source test case 502 from which it was generated from), the challenge is a failed challenge, and as such the user might find it useful to use it later on for fine-tuning a foundation model or for retraining a machine learning model of the external AI system 302.

The system 201 stores the generated data in the AI asset store 326 and provides each item's ID over the API. If a new session is carried out on the same source set of test cases 502, the system 201 can provide an even richer set of generated cases by building on what has already been generated in previous sessions. This is then carried out by offsetting the granularity boundaries of the generated dataset, and by using properties and property combinations which haven't been used before.

At step 228, the analyser 322 reports results of the analysis.

At step 299 the method ends.

In an alternative embodiment, an increase in complexity between successive iterations follows a defined complexity function. For example, the complexity increase may be linear, or exponential. The skilled person will understand that many complexity functions may defined.

In an alternative embodiment, the system 201 runs clustering (affinitive propagation in the prototype) on the test results which were provided and presents the result for the user who can see if certain combinations of properties are problematic. Besides the combinatorial analysis, the system creates a frequency table of which single properties that are causing most problems and on which level of complexity they do so. The system also calculates the ratio of features causing problems and non-feature related modifications which create wrong results. The ratio is also displayed for the user who can see if there are general problems with the external text analysis (not necessarily the features) or if it's sensitive to modifications of the features themselves (if any).

In an alternative embodiment, the external AI system 302 downloads all the generated cases and a description of which ones that failed from the system 201, so the external AI system 302 can be retrained or fine-tuned on these cases to improve it.

In an alternative embodiment, test cases 502 are suitable for an audio analysis external AI system 302, and are modified to produce alternative test cases 514, 516, 518.

In an alternative embodiment, generative AI is used to which changes voice style and gender by modifying formants and other characteristics. For neutral/non-speech audio various audio characteristics (such as different microphone types and recording characteristics) using generative AI can be used.

In an alternative embodiment of the present invention audio 502 is transmitted to the controller 402. The audio 502 is transmitted to a separator (not depicted). The separator chooses between one or more implementations of Transient Harmonic separation. Factors that decide which implementation that should be used are computation time and output quality. The separator separates the transients from the harmonics, for example using FFT, inverse FFT and a sliding window technique in the frequency domain, or using onset analysis and compression techniques in the time domain, or other methods. Harmonics are scaled with weightings generated by the controller 402. The alternative test cases 514, 516, 518 are created using a combination of weighted harmonics and transients created by the controller 402, and then passed to the speech-to-text system 302. The clean audio is also passed to the speech-to-text system 302. The two outputs are compared using a distance function.

1. A computer implemented method for enhancing an artificial intelligence, AI, audio system, the method comprising:
receiving at least one audio test case, the at least one test case comprising a set of sound components;
generating at least one an alternative audio test case, wherein generating comprises using a generative AI model to provide a first modification to the at least one test case;
challenging the external AI audio system with the at least one audio test case, and with the at least one alternative audio test case to determine a set of results; and
comparing the results, using a distance function, to determine if the respective modification causes a problem in the external AI audio system.

2. The method of claim 1, wherein the AI audio system is one of a list, the list comprising: a speech-to-text system; a voice recognition system; a music recognition system; a text-to-speech system; and aspatial audio processing system.

3. The method of claim 1, wherein generating for enhancing an external artificial intelligence, AI, audio system comprises generating a further one of the alternative audio test cases, the further one of the alternative audio test cases comprising a second modification.

4. The method of claim 1, wherein generating the at least one alternative audio test case comprises generating a set of iterative alternative audio test cases, comprising a series of modifications to the at least one audio test case.

5. The method of claim 4, further comprising:
in response to receiving the at least one audio test case, creating a trajectory;
for each increment on the trajectory, determining a set of operations mnemonics to apply;
and wherein generating the set of iterative alternative audio test case comprises applying one of the operations mnemonics to the at least one audio test case to provide a corresponding modification.

6. The method of claim 3, wherein the second modification comprises a greater complexity level than the first modification, the complexity level comprising a level of feature change applied to the corresponding at least one alternative audio test case.

7. The method of claim 6, wherein the complexity level between the first modification and the second modification follows a complexity function.

8. The method of claim 1, further comprising:
in response to determining a problem in the external audio AI system, sending information about the at least one alternative audio test case to the external audio AI system.

9. The method of claim 1, wherein a parameter defines which type of modifications the system is allowed to perform.

10. The method of claim 1, wherein the distance function is a user defined distance function.

11. The method of claim 4, further comprising analysing the results to determine a frequency and/or clustering of the results.

12. A system for enhancing an external artificial intelligence, AI, audio system, the system comprising: a memory; at least one processor in communication with memory; and program instructions executable by one or more processor via the memory to perform a method comprising:
receiving at least one audio test case, the at least one test case comprising a set of sound components;
generating at least one an alternative audio test case, wherein generating comprises using a generative AI model to provide a first modification to the at least one test case; and
challenging the external audio AI with the at least one audio test case, and with the at least one alternative audio test case to determine a set of results; and
comparing the results, using a distance function, to determine if the respective modification causes a problem in the external AI audio system.

13. The system of claim 12, wherein the AI audio system is one of a list, the list comprising: a speech-to-text system; a voice recognition system; a music recognition system; a text-to-speech system; and aspatial audio processing system.

14. The system of claim 12, wherein generating at least one alternative audio test case comprises generating a further one of the alternative audio test cases, the further one of the alternative audio test cases comprising a second modification.

15. The system of claim 12, wherein generating at least one alternative audio test case comprises generating a set of iterative alternative audio test cases, comprising a series of modifications to the at least one audio test case.

16. The system of claim 15, further comprising:
responsive to receiving the at least one audio test case, creating a trajectory;
for each increment on the trajectory, determining a set of operations mnemonics to apply;
and wherein generating the set of iterative alternative audio test case comprises applying one of the operations mnemonics to the at least one audio test case to provide a corresponding modification.

17. The system of claim 14, wherein the second modification comprises a greater complexity level than the first modification, the complexity level comprising a level of feature change applied to the corresponding at least one alternative audio test case.

18. The system of claim 17, wherein the complexity level between the first modification and the second modification follows a complexity function.

19. The system of claim 12, further comprising:
in response to determining a problem in the external audio AI system, sending information about the at least one alternative audio test case to the external audio AI system.

20. A computer program product for enhancing an external artificial intelligence, AI, audio system, the computer program product comprising a computer readable storage medium having program instructions embodied therewith, the program instructions executable by a processor to cause the processor to perform a method comprising:
receiving at least one audio test case, the at least one test case comprising a set of sound components;
generating at least one an alternative audio test case, wherein generating comprises using a generative AI model to provide a first modification to the at least one test case;
challenging the external audio AI system with the at least one audio test case, and with the at least one alternative audio test case to determine a set of results; and
comparing the results, using a distance function, to determine if the respective modification causes a problem in the external AI audio system.
